(19) United States
(12) Patent Application Publication
(10) Pub. No.: US 2017/0072933 A1
(43) Pub. Date: Mar. 16, 2017

(54) METHOD FOR OPERATING A FUNCTIONAL ELEMENT

(71) Applicant: BorgWarner Inc., Auburn Hills, MI (US)

(72) Inventor: Thomas BUCHHOLZ, Stockach (DE)

(21) Appl. No.: 15/264,678

(22) Filed: Sep. 14, 2016

(30) Foreign Application Priority Data
Sep. 15, 2015 (DE) 102015217616.9

(51) Int. Cl. B60W 10/30; F02B 67/08; F16D 48/06

(52) U.S. Cl. CPC B60W 10/30; F16D 48/06; F02B 67/08; B60K 25/02

(57) ABSTRACT

The invention relates to a method for operating a functional element (1) which can be driven by a main drive (2) via a slip clutch (3) and/or by an auxiliary drive (4) which is coupled to the clutch (3), comprising the following method steps: determining the efficiency curve (η_{K}) of the clutch (3); determining the efficiency curve (η_{HA}) of the auxiliary drive (4); superimposing the efficiency curves (η_{K}, η_{HA}); deriving an operating zone diagram (7) from the physical limits (n_{E}, n_{Kmax}, n_{HAmax}, n_{I}, G_{IK}) of the clutch (3) and the auxiliary drive (4); and optimizing the interplay of clutch (3) and auxiliary drive (4) determined by the superimposition of the efficiency curves (η_{K}, η_{HA}) with respect to an optimized overall efficiency curve (ηₒₚₜ) of the auxiliary drive (4) and the clutch (3) and/or a minimized heat generation of the clutch (3).

### CROSS-REFERENCE TO RELATED APPLICATIONS

This application claims the benefit of German Patent Application No. 102015217616.9 filed Sep. 15, 2016, the disclosure of which is herein incorporated by reference in its entirety.

The invention relates to a method for operating a functional element according to claim 1.

An functional element of this type may, for example, be a fan wheel, which is driven by the motor of a motor vehicle to generate a current of air through a radiator of the motor vehicle, wherein a coupling, in particular, in the form of a fluid-friction clutch, may be provided between the internal combustion engine and the fan wheel.

The object of the present invention is to create a method for operating a functional element by means of which the functional element may be operated in different operating modes, and by means of which the slip heat of the clutch and the overall efficiency for operating the functional element may be improved.

The solution to this problem is carried out by the features of claim 1.

According to the invention, a method is created for operating a functional element which may be driven by a main drive via a slip clutch and/or by an auxiliary drive, wherein the auxiliary drive is coupled to the clutch.

According to the method steps according to the invention, first, the efficiency curve of the clutch and the efficiency curve of the auxiliary drive are determined. These two efficiency curves are superimposed, by which means it is possible to determine ranges in which it is logical, at least according to the two efficiency curves of the clutch and the auxiliary drive, to operate either only the clutch or the auxiliary drive, or both components simultaneously. This analysis of the efficiency curves through superimposition of the same is, however, only a preparatory measure of the method according to the invention. As a further method step, an operating zone diagram is derived from the physical limits of the clutch and the auxiliary drive. These physical limits are usually an input or output rotational speed of the functional element (auxiliary unit), the maximum speed of the clutch, the maximum speed of the auxiliary drive, the drag speed of the clutch, and the slip heat limit, which represents the limit at which the clutch may be damaged or even destroyed by overheating.

As the last method step according to claim 1, the interplay of clutch and auxiliary drive determined by the superimposition of the efficiency curves is optimized with respect to an optimized overall efficiency of the auxiliary drive and the clutch and/or a minimized heat formation of the clutch.

The subclaims have advantageous refinements of the invention as content.

It is thus possible in particular that each static and/or dynamic operating point of the operating zone diagram is considered when carrying out the method according to the invention.

It is hereby provided in another particularly advantageous embodiment that the optimization of the interplay of clutch and auxiliary drive is carried out under consideration of operating states of the main drive. For example, the partial load range and/or the full load range of the main drive may be hereby considered as operating states.

Using the method according to the invention advantageously achieves that any type of auxiliary units may be used as functional elements. In particular, fan wheels or pump wheels are used as functional elements.

An internal combustion engine may be considered as the main drive in the method according to the invention.

A fluid-friction clutch, in particular, is used as the slip clutch.

Auxiliary drives may be electric motors or also hydraulic motors, wherein, for example, during use of an electric motor in a motor vehicle, the alternator of the motor vehicle may be used as the power or current source.

The switch from full load to coasting mode of the main drive may be used, for example, as a dynamic operating time point, which may be considered, in addition to static operating time points, in the operating zone diagram. During this switch, the clutch reacts too slowly so that too much torque is transmitted, which is compensated for according to the invention in that the auxiliary drive switches on and the clutch brakes in order to accelerate the drainage of clutch fluid from the working chamber of the clutch, in the case that a fluid-friction clutch is used.

Additional details, features, and advantages of the invention arise from the subsequent description of embodiments with reference to the drawings:

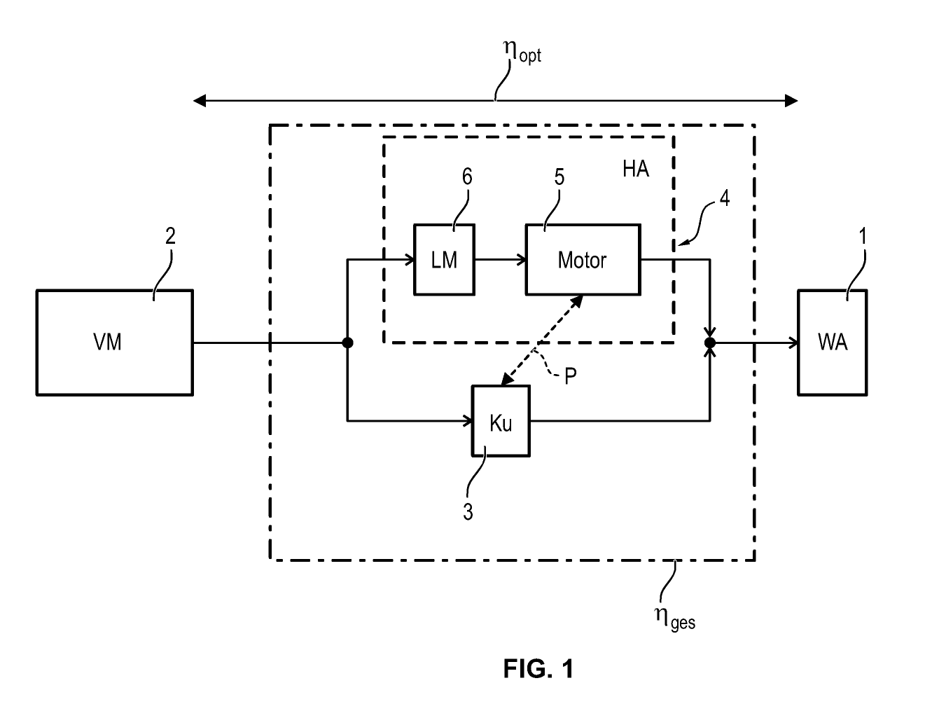

FIG. 1 shows a highly simplified schematic representation of a drive unit for a functional element, in which the method according to the invention may be used;

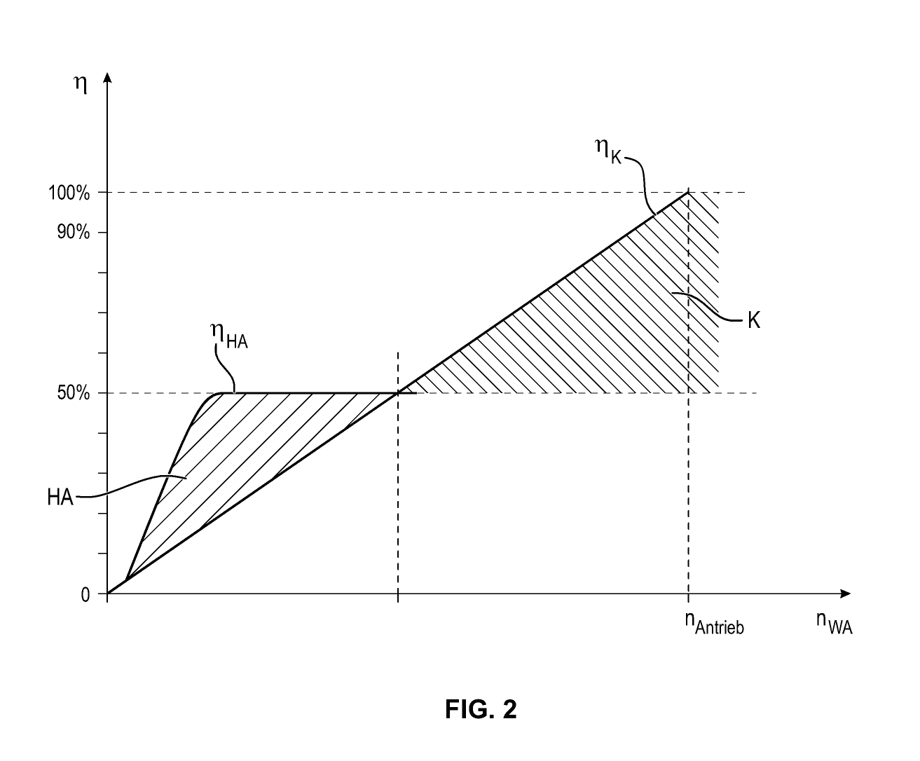

FIG. 2 shows a highly simplified schematic representation of the superimposing of the efficiency curves of a clutch and an auxiliary drive according to three method steps of the method according to the invention; and

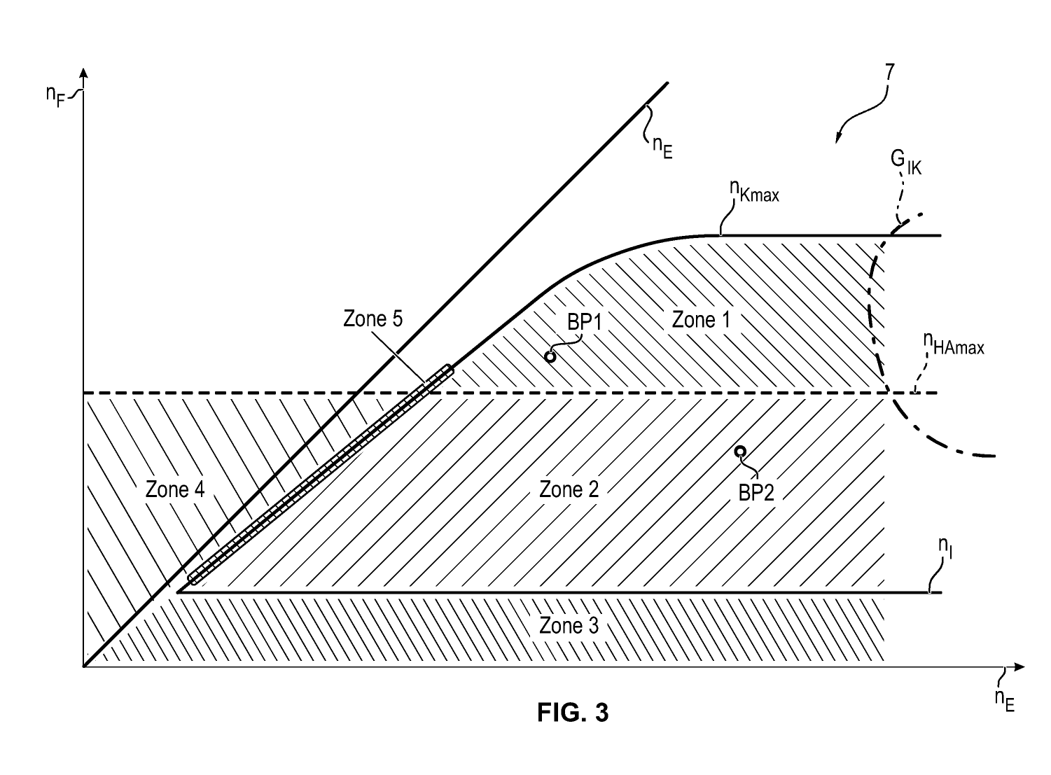

FIG. 3 shows an operating zone diagram of the method according to the invention.

A block diagram is depicted in FIG. 1, which in a highly simplified way shows an arrangement for operating a functional element 1, which may be, for example, a fan wheel or a pump wheel.

The arrangement comprises, in addition to functional element 1, a main drive 2, which may, for example, be an internal combustion engine.

This main drive 2 drives functional element 1 via a slip clutch 3 and/or an auxiliary drive 4, which may comprise an electric motor 5 and a current source 6, for example, the alternator of a motor vehicle, in which main drive 2 is arranged.

Clutch 3 and electric motor 5 of auxiliary drive 4 are, as symbolized by arrow P, coupled, for example, via a belt drive, via which a positive or negative torque may be transmitted to clutch 3, wherein a positive torque is a drive torque and a negative torque is a braking torque.

It is furthermore clear from FIG. 1 that the overall efficiency η_{ges} is understood to be efficiency of the arrangement, which comprises auxiliary drive 4 and clutch 3.

The optimization efficiency ηₒₚₜ is symbolized by the corresponding double arrow in FIG. 1, wherein the range of this optimized efficiency may extend into the range of main drive 2, since, in a particularly preferred embodiment, the optimization of the interplay of clutch 3 and auxiliary drive 4 may be carried out under consideration of the operating states of main drive 2.

FIG. 2 clarifies a diagram, in which, after determining the efficiency curve η_{K} of clutch 3 and determining the efficiency curve η_{HA} of auxiliary drive 4, a superimposition of these curves is carried out. From the superimposition of these curves, it may be determined in a first approximation that the range HA, shown striped in FIG. 2, may be particularly suited for the use of the auxiliary drive, as efficiency η_{HA} in this range lies above efficiency η_{K} in the clutch. The second range K, designated with striping, correspondingly represents a range in which, in a first approximation, the use of clutch 3 alone is particularly preferred, wherein, despite these ranges HA and K, the diagram according to FIG. 2 does not exclude the fact that a superimposition of the use of clutch K[sic: 3] and auxiliary drive 4 would also be preferred.

This arises from the depiction of FIG. 3, which depicts an operating zone diagram 7, which was determined from the physical limits of clutch 3 and auxiliary drive 4. These physical limits are the input or output speed of the auxiliary units or functional element 1, which usually represents the primary speed in the system according to FIG. 1.

This variable is represented in FIG. 1 [sic: 3] by the reference numeral n_{E}.

The speed n_{F} is the speed of functional element 1, which would represent the secondary speed in the system depicted in FIG. 1.

The additional physical limits are the maximum speed n_{Kmax} of clutch 3, the maximum speed n_{HAmax} of auxiliary drive 4, the drag speed n_{I} of clutch 3 and the slip heat limit G_{IK} , which depicts the limit of clutch 3, at which it may be damaged or destroyed due to overheating.

Five zones arise from these variables in the particularly preferred embodiment, depicted in FIG. 3, of the method according to the invention.

Zone 1 depicts a range in which the operation of clutch 3 alone is particularly preferred, where auxiliary drive 4 is, in contrast, passive, which means that it passively moves due to the coupling along with clutch 3, but does not function actively as a functional element. In Zone 1, the speed of clutch 3 is correspondingly controlled.

Zone 2 depicts the range in which a combined/mixed operation of clutch 3 and auxiliary drive 4 is particularly preferred. In this operation, clutch 3 and auxiliary drive 4 are correspondingly jointly controlled in operation, which means that auxiliary drive 4, or electric motor 5 thereof according to FIG. 1, are both actively functioning. The drag speed n_{I} of clutch 3, at which clutch 3 is switched off, is indicated below Zone 2.

Zone 3 depicts the range in which clutch 3 is switched off and auxiliary drive 4, or electric motor 5 thereof, may deliver a negative speed to clutch 3 due to the coupling with the same in order to brake clutch 3.

Zone 4 depicts the range in which clutch 3 is usually completely shut off and the drive is carried out exclusively by auxiliary drive 4 or electric motor 5 thereof, which is thus controlled in operation. As clarified in FIG. 3, the upper limit for Zones 2 and 4 is the respective maximum speed n_{HAmax} of the auxiliary drive in this zone, which in FIG. 3 is depicted, for example, by the same value. The lower limit of Zone 4 arises from the maximum speed n_{Kmax} of clutch 3.

Finally, Zone 5 depicts a range of low slip and is correspondingly a transition range to Zone 2, in which clutch 3 is disengaged or switched off and auxiliary drive 4 or electric motor 5 thereof is driven in braking mode, in that the phases thereof are either short-circuited by the control electronics or electric motor 5 is driven in a mode which actively generates a braking torque, thus counter to the rotational direction of electric motor 5 in which the electric motor delivers a drive torque.

As explained in the beginning, according to the representation of FIG. 3, the interplay of clutch 3 and auxiliary drive 4 may be optimized, specifically with respect to an optimized overall efficiency of auxiliary drive 4 and clutch 3, and/or a minimized heat generation of clutch 3, which would mean, corresponding to diagram 7 in FIG. 3, that the slip heat limit G_{IK} in the diagram of FIG. 3 may displaced to the right and/or upward.

In addition to the preceding written disclosure of the invention, reference is explicitly made hereby to the graphic representation of the invention in FIGS. 1 through 3 to supplement the disclosure of the invention.

### LIST OF REFERENCE NUMERALS

1 Functional element
2 Main drive
3 Clutch
4 Auxiliary drive
5 Electric motor
6 Current source/Alternator
7 Operating zone diagram
BP1, BP2 Examples for operating points in diagram 7

1. A method for operating a functional element (1) which can be driven by a main drive (2) via a slip clutch (3) and/or by an auxiliary drive (4) which is coupled to the clutch (3), comprising the following method steps:
determining the efficiency curve (η_{K}) of the clutch (3);
determining the efficiency curve (η_{HA}) of the auxiliary drive (4);
superimposing the efficiency curves (η_{K}, η_{HA});
deriving an operating zone diagram (7) from the physical limits (n_{E}, n_{Kmax}, n_{HAmax}, n_{I}, G_{IK}) of the clutch (3) and the auxiliary drive (4); and
optimizing the interplay of clutch (3) and auxiliary drive (4) determined by the superimposition of the efficiency curves (η_{K}, η_{HA}) with respect to an optimized overall efficiency curve (ηₒₚₜ) of the auxiliary drive (4) and the clutch (3) and/or a minimized heat generation of the clutch (3).

2. The method according to claim 1, characterized in that each static and/or dynamic operating point (BP1, BP2) of the operating zone diagram (7) is considered.

3. The method according to claim 1, characterized in that the optimization of the interplay of the clutch (3) and the auxiliary drive (4) is carried out under consideration of the operating states of the main drive (2).

4. The method according to claim 3, characterized in that the idle range and/or partial load and/or full load range and/or the switching off of the main drive (2) is considered as the operating state.

5. The method according to claim 1, characterized in that a fan wheel is used as the functional element (1).

6. The method according to claim 1, characterized in that a pump wheel is used as the functional element (1).

7. The method according to claim 1, characterized in that an internal combustion engine is used as main drive (2).

8. The method according to claim 1, characterized in that a fluid-friction clutch is used as the clutch (3).

9. The method according to claim 1, characterized in that the auxiliary drive (4) uses an electric motor (5).

10. The method according to claim 1, characterized in that the auxiliary drive (4) uses a hydraulic motor.

11. The method according to claim 2, characterized in that a switch of the main drive (2) from full load to coasting or partial load operation is considered as a dynamic operating point.
